(19) United States
(12) Patent Application Publication
(10) Pub. No.: US 2009/0228965 A1
(43) Pub. Date: Sep. 10, 2009

(54) Process of Authenticating a User

(76) Inventor: William Klippgen, Singapore (SG)

Correspondence Address: FROMMER LAWRENCE & HAUG LLP, 745 FIFTH AVENUE, NEW YORK, NY, 10151, US

(21) Appl. No.: 12/105,526

(22) Filed: Apr. 18, 2008

(30) Foreign Application Priority Data
Mar. 4, 2008 (AU) 2008201012

(51) Int. Cl. H04L 9/32

(52) U.S. Cl. 726/6

(57) ABSTRACT

A system for authenticating a prospective user is disclosed. The system has an address receiver for receiving an address of an email account associated with the prospective user. It also includes a device number receiver for receiving a device number of a device associated with the prospective user. The system has an email sender for sending an email containing authentication information to the email account and a message sender for sending different authentication information to the device. The system includes a message receiver for receiving a first message and a second message from the prospective user. There is a confirmer for confirming that the first message is the authentication information contained in the email and confirming that the second message is the different authentication information sent to the device.

This application claims priority benefits of Australian Patent Application Number 2008201012 filed Mar. 4, 2008, the disclosure of which is hereby incorporated by reference.

### FIELD OF THE INVENTION

The invention generally relates to registering a prospective user for a web site, and particularly, but not exclusively to a process for authenticating a prospective user.

### BACKGROUND ART

FIG. 1 shows a prior art process of authenticating a prospective user of a website. At step 10, the prospective user enters their email address at a web page provided by a system. The system then sends an authentication code such as a password or equivalent token to the email address at step 20. The prospective user retrieves the authentication code from the email sent by the system and then at step 30 enters the authentication code at a web page served by the system 30. The system then makes a decision at step 40, the decision involving a comparison of the authentication code sent to the email address and the authentication code entered at the website by the prospective user. If the sent and entered codes match then the system considers that the prospective user has been authenticated. If the entered authentication code and the sent code do not match, however, the system considers that the user is not authenticated.

### SUMMARY OF THE INVENTION

According to a first aspect of the present invention there is provided a process for authenticating a prospective user, the process comprising the steps of:

receiving an address of an email account associated with the prospective user;

receiving a device number of a device associated with the prospective user;

sending an email containing authentication information to the email account;

sending different authentication information to the device;

receiving a first message and a second message from the prospective user;

confirming that the first message comprises the authentication information contained in the email; and

confirming that the second message comprises the different authentication information sent to the device.

In some embodiments the device is a handheld mobile device. The device maybe a mobile or cell telephone, and the device number a telephone number of the mobile or cell telephone. The step of sending the different authentication information to the device may comprise the step of sending the different authentication information to the mobile or cell telephone over a Short Message Service (SMS). The step of sending the different authentication information may comprise the step of using the device number.

In some embodiments the prospective user is a prospective user of a website.

In some embodiments, the step of receiving the address of the email account and the device or telephone number comprises a prior step of providing one or more web pages. The step of providing the web page may comprise the step of providing a web page arranged for the prospective user to enter the address and the telephone number. The step of providing the web page may comprise providing a web page arranged for the user to enter one or more of a user name desired by the user, a first name, a second name, a street or postal address, an alternative phone number, a fax number and a date of birth.

In some embodiments the process also comprises the step of confirming that the device or telephone number corresponds to a predetermined geographical region. The step of confirming that the device or telephone number corresponds to a predetermined geographical region comprises the step of checking a leading set of digits of the device or telephone number.

In some embodiments the step of receiving the first message and the second message comprises the step of providing a web page arranged for the user to enter the first message and the second message. The step of providing this web page may comprise the step of providing a web page arranged for the user to enter the user name.

In some embodiments the process further comprises the step of receiving a user created password for future access to the website. This step may comprise providing a web page arranged for the prospective user to enter the user created password.

In some embodiments the process comprises the step of providing a web page displaying terms of use and privacy policy of the website. The method may comprise the step of receiving confirmation that the prospective user has read and accepted the terms of use and privacy policy of the website.

According to a second aspect of the present invention there is provided a process for authenticating a prospective user, the process comprising the steps of:

sending an address of an email account associated with the respective user;

sending a device number of a device associated with the respective user;

receiving an email containing authentication information in the email account;

receiving different authentication information via the device; and

sending a first message and a second message comprising the and the different authentication information respectively.

According to a third aspect of the present invention there is provided a system for authenticating a prospective user, the system comprising:

an address receiver for receiving an address of an email account associated with the prospective user;

a device number receiver for receiving a device number of a device associated with the prospective user;

an email sender for sending an email containing authentication information to the email account;

a message sender for sending different authentication information to the device;

a message receiver for receiving a first message and a second message from the prospective user; and

a confirmer for confirming that the first message comprises the authentication information contained in the email and confirming that the second message comprises the different authentication information sent to the device.

In some embodiments of the system there is included a web server connected to the internet. The address receiver and device number receiver, may comprise the web server. The web server may provide one or more web pages into which the user enters one or more of the address, the device number, the first message and the second message. The web server may also provide a web page into which the email account and device number may be entered by the user. The web server may be connected to the internet and use a secure socket layer or another type of secure connection.

In some embodiments the system includes an email server. The email sender may comprise the email server. The email server may send the email containing the authentication information to the email account.

In some embodiments the message receiver and the confirmer include the web server.

The system may comprise a data communication device. The data communication device may comprise one or more of a modem, router, gateway, or Wi-Max transceiver. The data communication device may be connected to the internet. The data communication device may be in communication with the email and web servers.

In some embodiments the message sender comprises a SMS server. The SMS server may be in communication with a SMS gateway.

In some embodiments of the invention the email sender is arranged for sending an email to a person nominated by a user of the system notifying the nominated person of the website. The email may comprise a URL and/or a URI. The URL and/or URI may include information uniquely identifying the prospective user. The system may be arranged to provide a web page for the nominated person to enter information. The information may be registration information. The system may be arranged to reward the user for use of the website by the nominated person. The system may be arranged to reward the prospective user for the nominated person starting a reverse auction tender or quotation process. The system may be arranged to reward the prospective user with a voucher redeemable on the website. Alternatively, the system is arranged to provide a URL and/or a URI to the prospective user comprising information uniquely identifying the user. The URL and/or URI may be located at the bottom of a plurality of emails sent by the nominated person to a plurality of persons. The URL and/or URI may be used as part of an email tag by the prospective user. The email tag may promote the website.

In accordance with a fourth aspect, the present invention provides a computer program comprising instructions for controlling a computer to implement a method in accordance with the first aspect of the invention.

In accordance with a fifth aspect, the present invention provides a computer readable medium providing a computer program in accordance with the fourth aspect of the invention.

In accordance with a sixth aspect, the present invention provides a computer program comprising instructions for controlling a computer to implement a method in accordance with the second aspect of the invention.

In accordance with the seventh aspect, the present invention provides a computer readable medium providing a computer program in accordance with the sixth aspect of the invention.

The term “server” in this specification is intended to encompass any combination of hardware and software that performs services for connected clients in part of a client-server architecture. The client and a server may be separate software running on a single piece of hardware or a plurality of connected pieces of hardware.

### BRIEF DESCRIPTION OF THE DRAWINGS

In order to achieve a better understanding of the nature of the invention embodiments of a process and system for authenticating a prospective user will now be described, by way of example only, with reference to the accompanying figures in which:

FIG. 1 is a flow diagram of a prior art method of authenticating a prospective user;

FIG. 2 is a flow diagram of an embodiment of a method of authenticating a prospective user in accordance with one aspect of the invention;

FIG. 3 shows one embodiment of a system for authenticating a prospective user.

FIG. 4 shows one embodiment of a first web page for a website including a “register now” button;

FIGS. 5-8 show various portions of one embodiment of a web page used in the method of FIG. 2, which includes text boxes for the prospective user to enter registration details, FIG. 5 being the top most web page portion and FIG. 8 being the bottom most web page portion;

FIG. 9 shows one embodiment of a web page used in the method of FIG. 2 which includes text boxes for the prospective user to enter authentication information;

FIG. 10 shows one embodiment of a web page used in association with the method of FIG. 2 which includes text boxes for the prospective user to enter a user created password;

FIGS. 11 and 12 shows embodiments of a web page used in association with the method of FIG. 2 which is part of an “invite a friend” reward program;

FIG. 13 shows one embodiment of a web page used in association with the method of FIG. 2 which is part of an “e-mail tag” reward program; and

FIG. 14 shows one embodiment of a web page used in association with the method of FIG. 2 including a text box for entry of a voucher code.

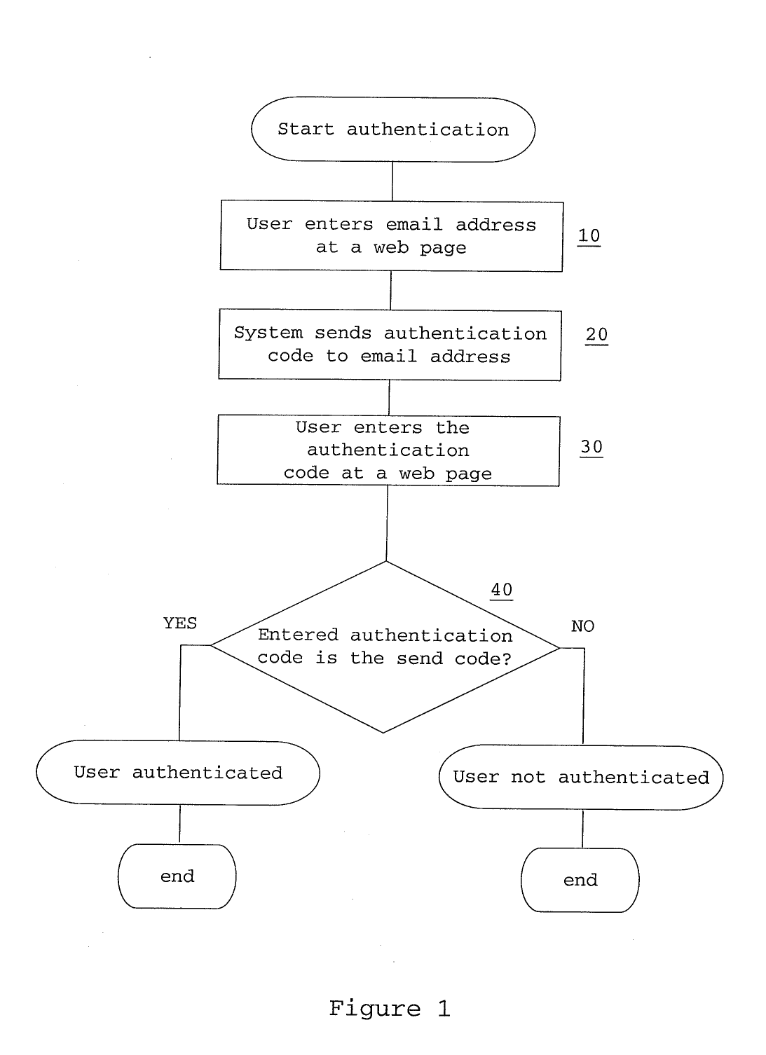

### DETAILED DESCRIPTION OF ONE EMBODIMENT

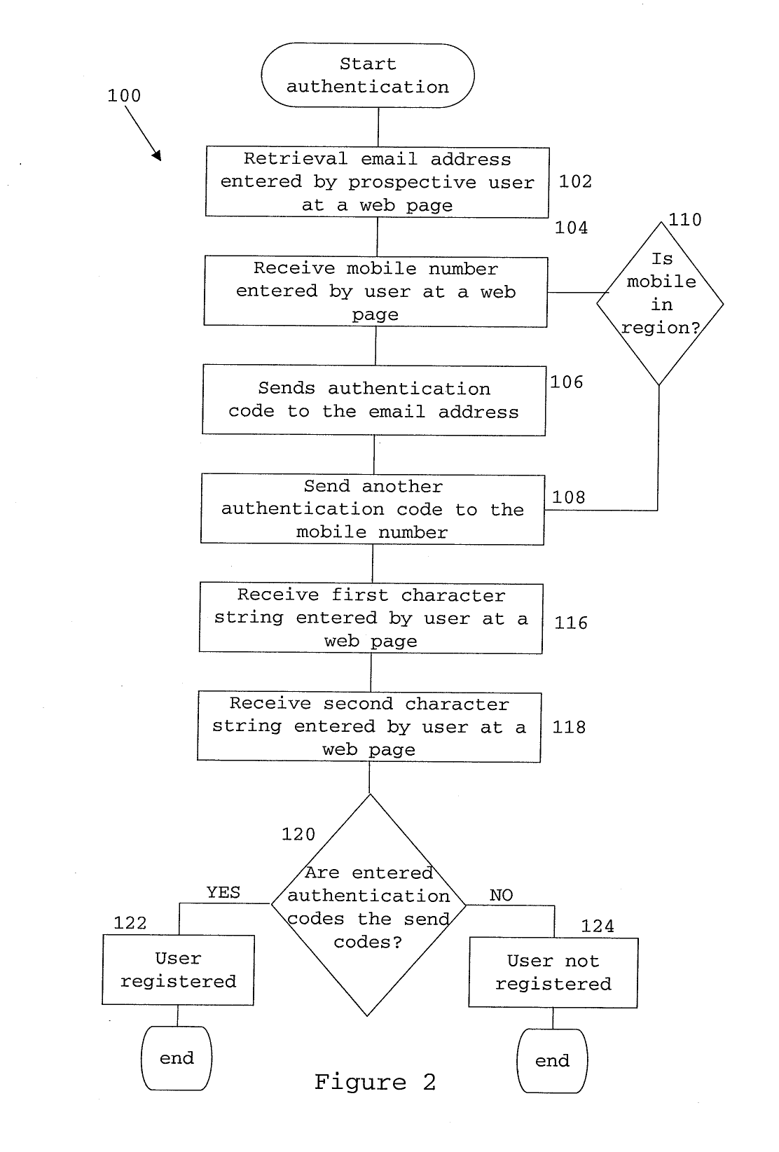

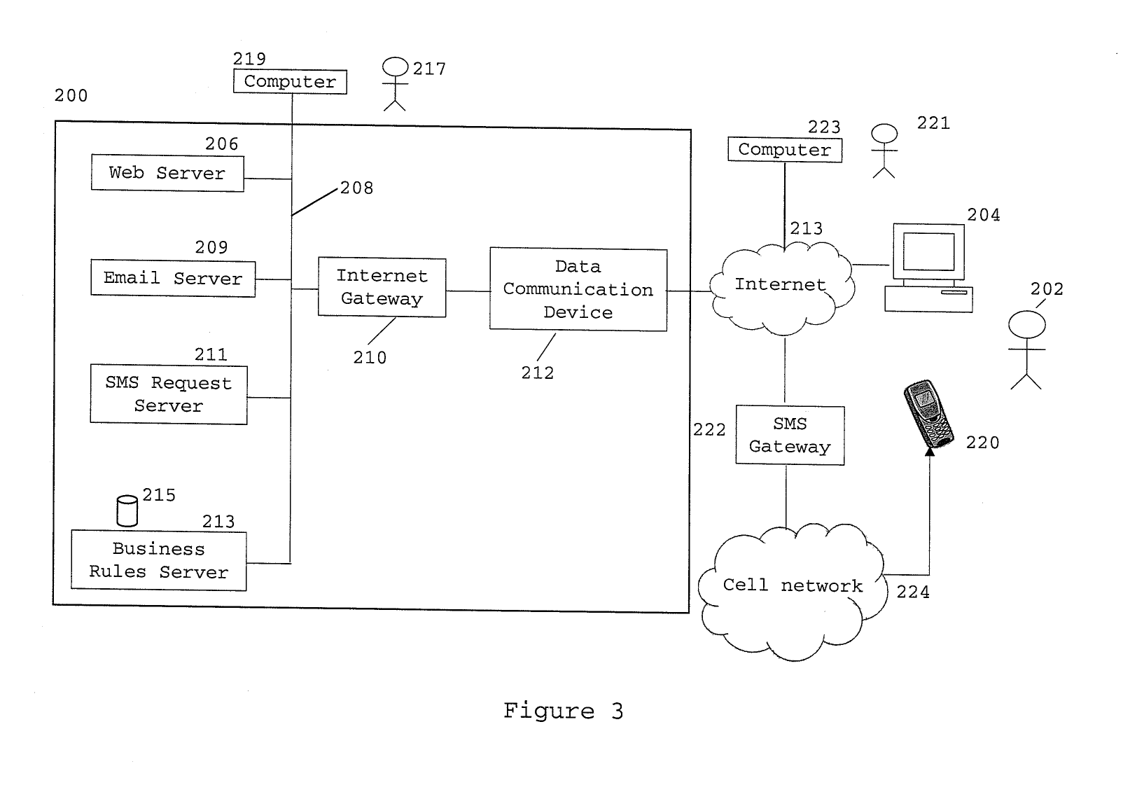

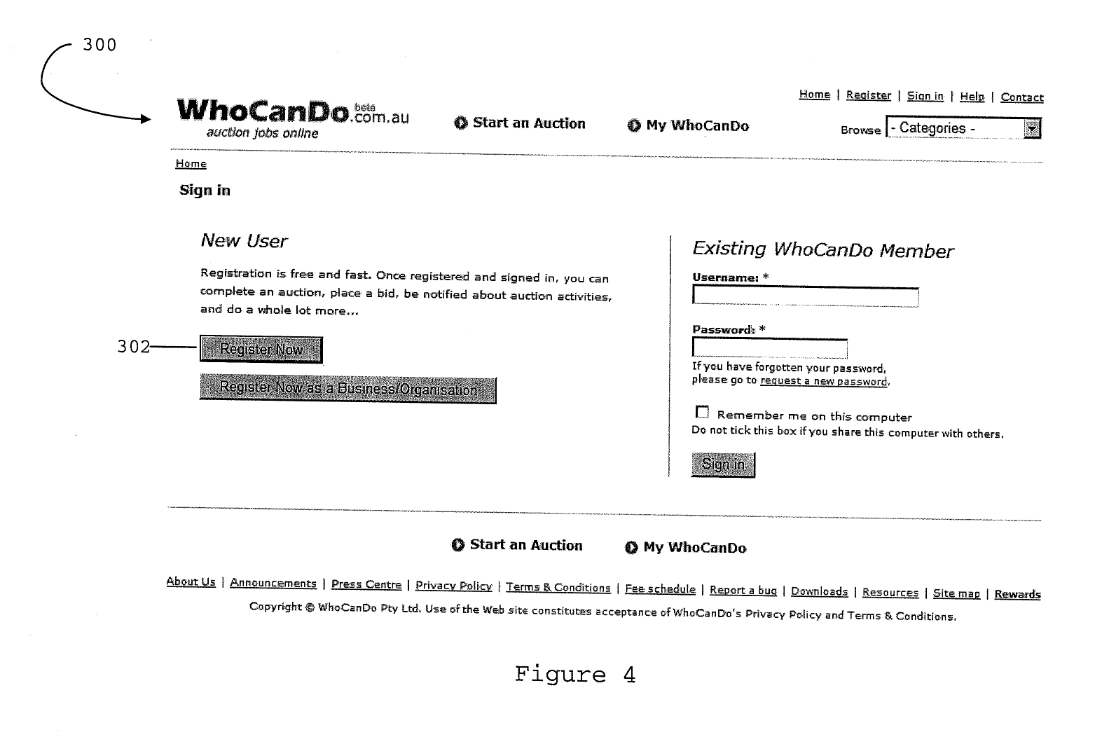

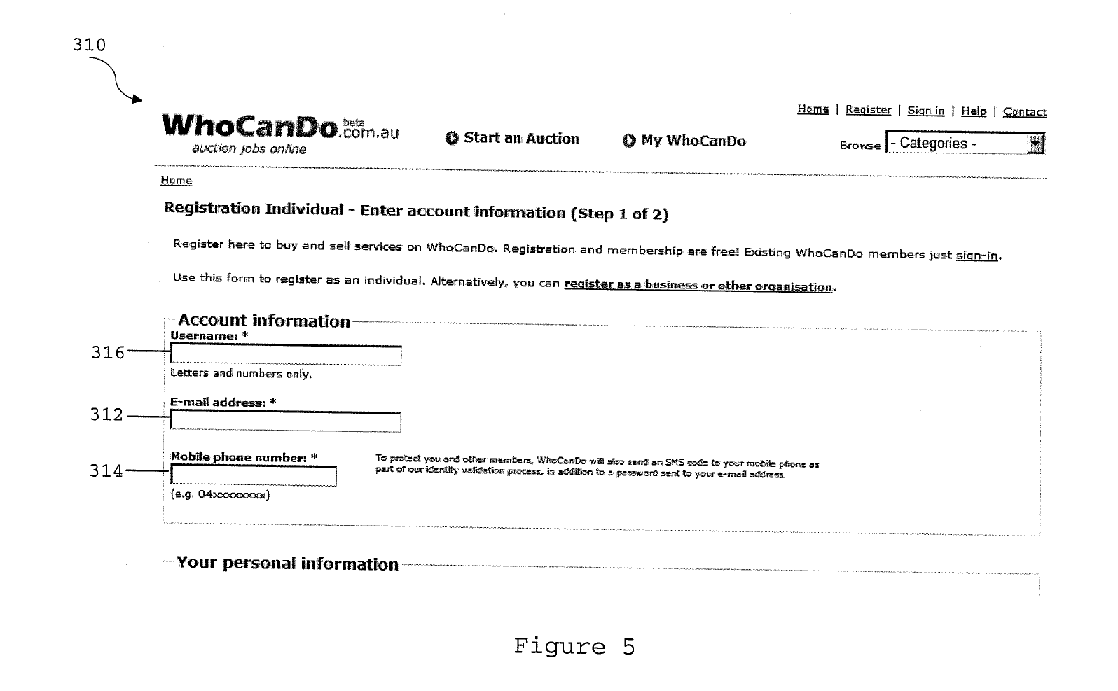

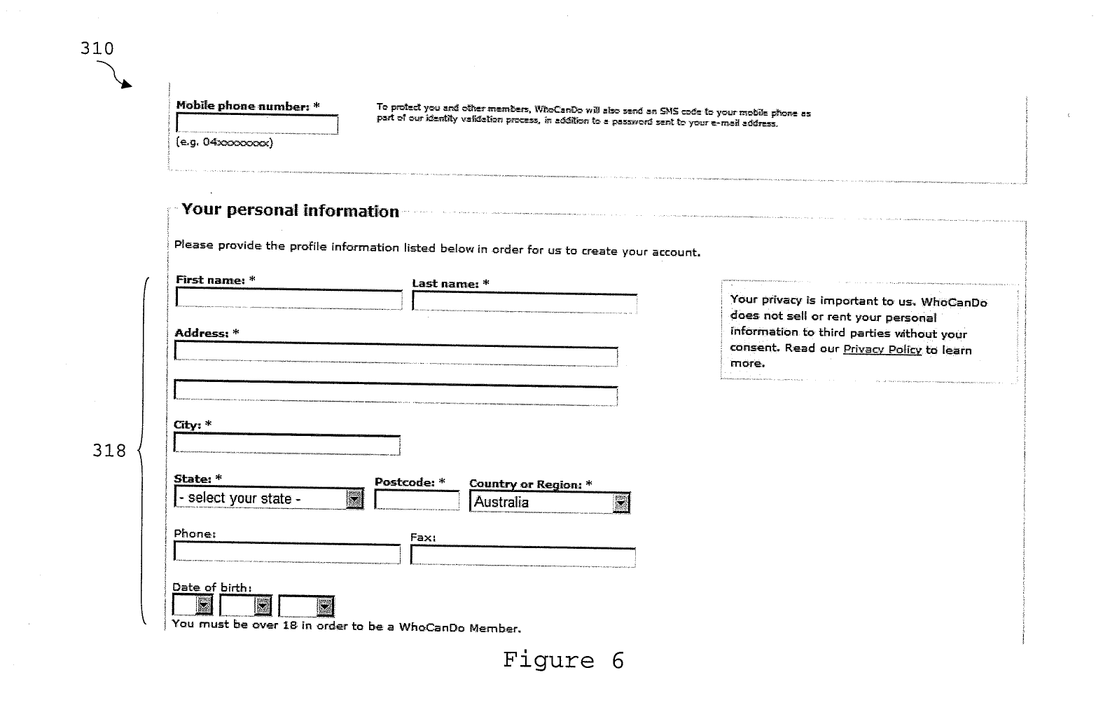

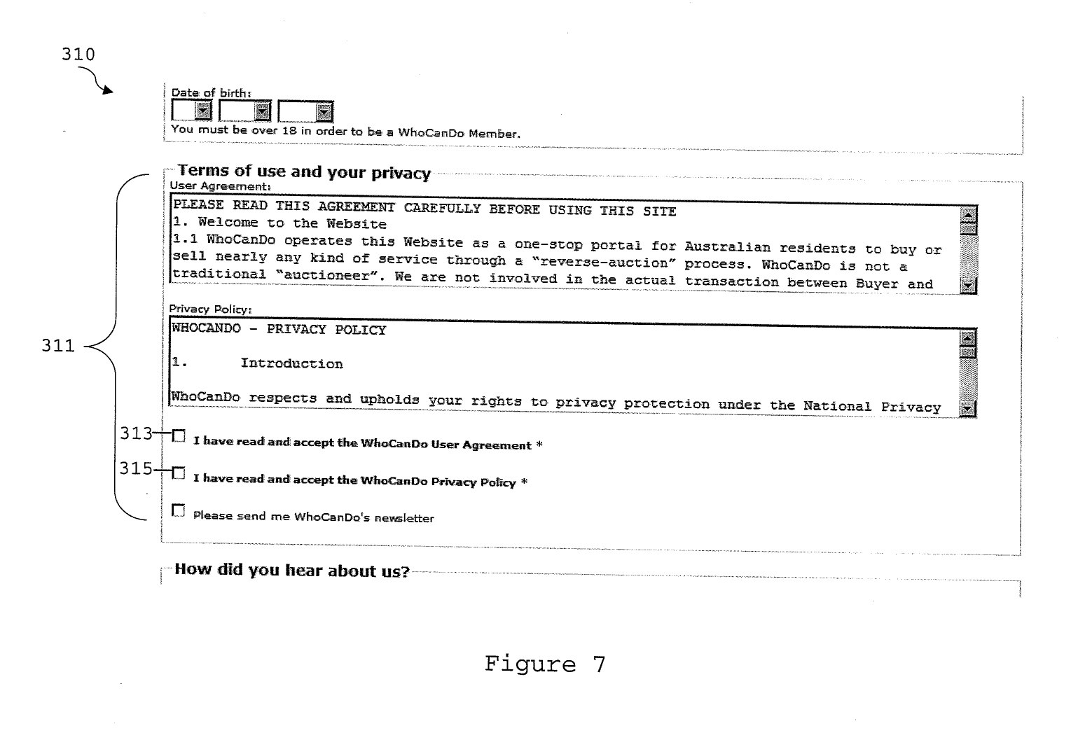

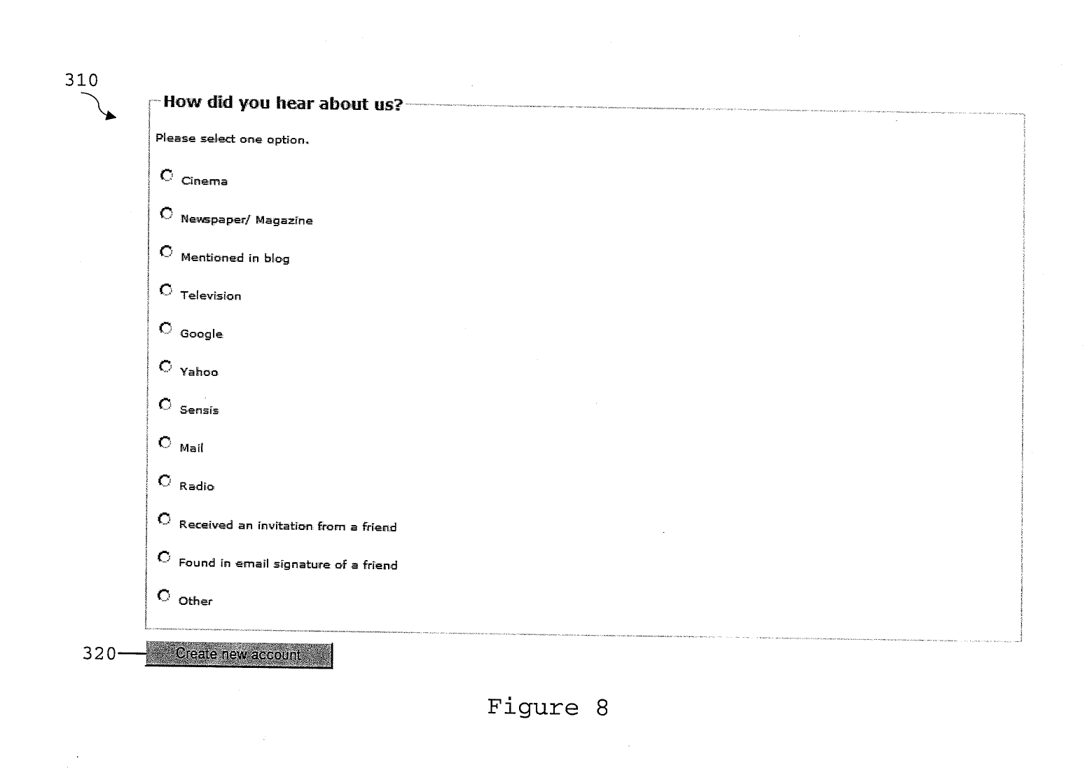

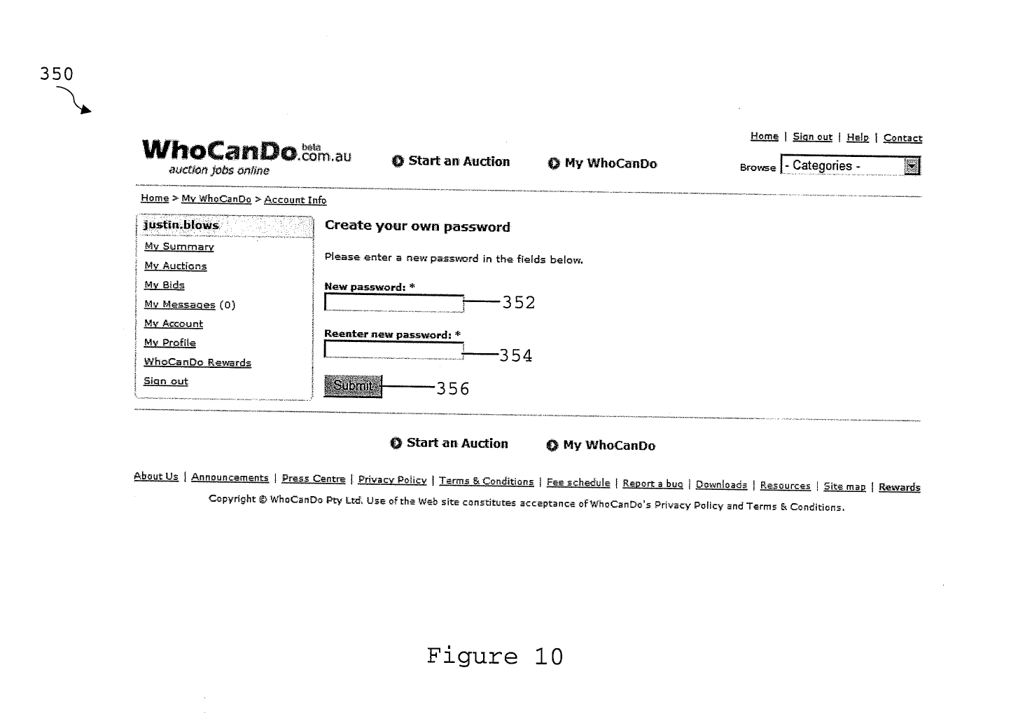

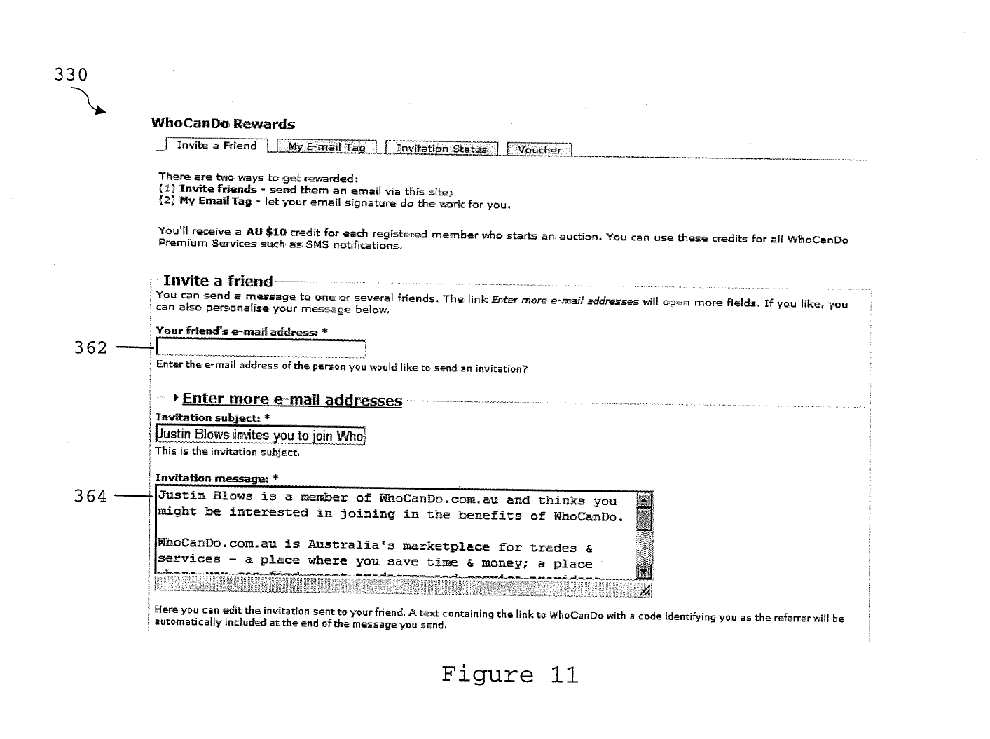

FIG. 2 shows a flow chart of the steps of a process for authenticating a prospective user of a web based service and is generally indicated by numeral 100. FIG. 3 shows the corresponding system which is generally indicated by the numeral 200. The process 100 is generally initiated by a prospective user pressing a register now button 302 on a sign in page 300 of a website such as that shown in FIG. 4. Web pages such as that shown in FIGS. 4-14 are served to the prospective user's 202 computer 204 by a system 200 web server 206. The web server 206 is connected via a local area network 208 to an internet gateway or router 210. The gateway 210 is connected to a data communication device 213 such as a modem or WiMax transceiver connected the internet 213, to which the user's 202 computer 204 is also connected. The internet connection uses a cryptographic protocol such as secure Socket Layer, preferably with 128 bit encryption, or Transport Layer Security. The web pages such as 300, are viewed and interacted with by the user 202 on the computer 204 using a web browser such as Internet Explorer. On pressing the register now button 302, the system provides or serves a web page 310. The web page 310 is shown as fragments in FIGS. 5-8. The web page 310 is arranged for the prospective user 202 to enter their email address and a telephone number of the user's 202 mobile or cell telephone 220 in text boxes 312 and 314 respectively. Text boxes are also provided to enter details such as a user name 316 desired by the user 202 for use on the website, personal details, postal details, and contact details 318. The user can then press a create new account button 320 which sends the details back to the web server 206 over the internet 213. Thus, the system 200 has received the address of an email account 312 and a mobile phone number 314 associated with the prospective user 202 by the prospective user 202 entering them at the web page 310. The system generates authentication information in the form of an authentication code and at step 106 sends the authentication code to the email address 312 from an email server 209. The system 200 also at step 108 sends different authentication information in the form of another authentication code to the mobile phone number 314 at step 108. The email address 312 is associated with the user 202 and is preferably the email address 312 commonly used by the user 202. The system also can use this email address 312 to send various future alerts and messages to prospective user 202 after the user. It will be appreciated that the mobile phone 220 may be some alternative device such as a blackberry or pager. The another authentication code sent to the mobile phone is sent over a short message service (SMS). The web server 206 instructs a message sender, in this embodiment a SMS request server 211, to send an authentication code via a SMS gateway 222 and a cellular network 224 to the mobile 220.

The system 100 incorporates software based on the DRUPAL platform and can be implemented using PHP programming language. The web pages are coded using one or more of HTML, cascading style sheets and JAVA code.

In some embodiments, the process of authentication also includes the step 110 of confirming that the mobile telephone number 314 corresponds to a mobile phone that has been issued in a predetermined geographical region, such as Australia. This may be achieved by checking a leading set of digits of the device or telephone number 314 entered by the user 202 at text box 314. For example, if the telephone number 314 is +232 1234 5678 then the number is found to be a Sierra Leone number, which disqualifies the user 202 from using the system 200. This is useful in limiting the service provided by the system 200 to a particular predetermined geographical region, such as Australia. Alternatively, the system 200 may check that the number 314 has 10 digits and starts with 04, which is consistent with an Australian mobile number.

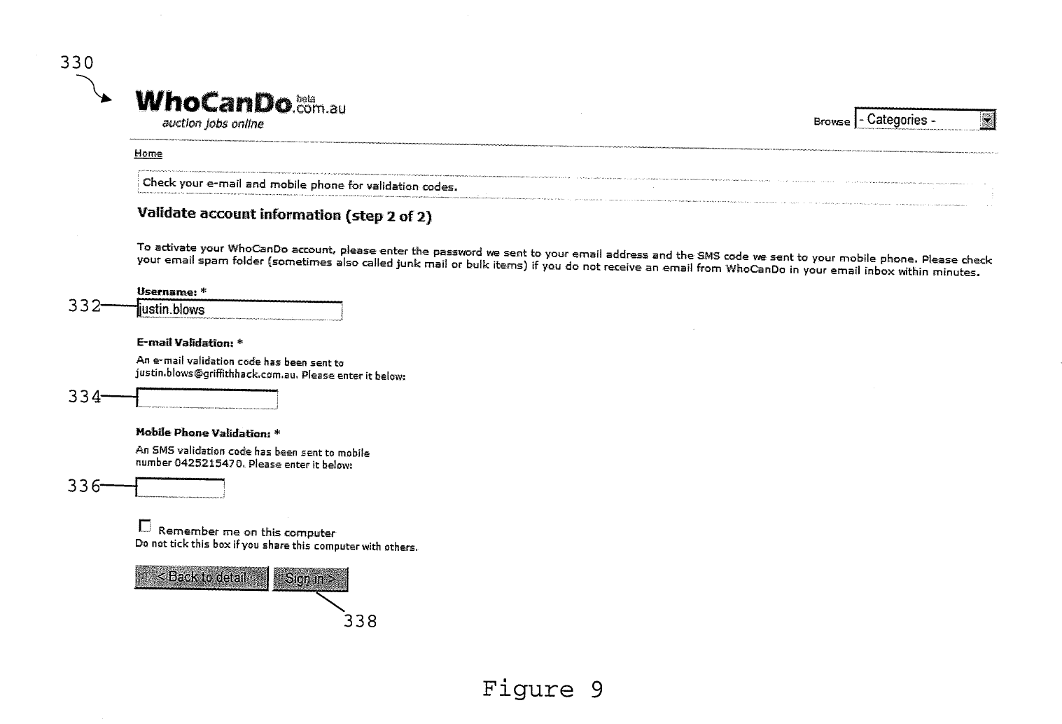

The user 202 retrieves the authentication code from the email account having the email address 312 and the another authentication code from the mobile phone 220 and the user 202 then enters messages in the form of character strings corresponding to each of the authentication codes in text boxes 334 and 336 respectively of another web page 330 provided by the system as shown in FIG. 9. The web page 330 also has a text box 332 for the user 202 to enter the desired user name entered at the text box 316 at web page 310. The user 202 then presses the signin button 338 which causes the computer 204 to send the authentication code and the another authentication code to the system 200. Corresponding to steps 116 and 118, the web server 206 of the system 200 receives the first character string 334 and the second character 336 string entered by the prospective user at web page 330. It will be appreciated that the authentication codes could each comprise any string of characters, and may be validation codes. The system 200 at method step 120 then confirms that the first character string received from the user 202 includes the authentication code contained in the email, and that the second character string received from the user 202 includes the another authentication code sent to the device or mobile phone 220. In some embodiments the messages must be identical to the authentication information. If confirmed 112, the system 200 has authenticated the user 202 otherwise the user 202 has not been authenticated 124. After the user 202 is authenticated, the system 202 may provide a web page 350 which allows the user to create a password by entering it into text box 352 and then again for confirmation in text box 354 and then pressing the submit button 356. In some embodiments of the authentication process 100 the user may be required to view a web page displaying terms of use and the privacy policy for website such as at 311 on web page 310. The user can confirm that the privacy policy and terms of use are accepted by checking boxes such as 313 and 315 on web page 104.

The system 200 also provides a method for the user 202 to change the registered mobile or cell telephone number. The system 200 provides a web page which includes account information. An option is selected to update the mobile number and the user 202 enters the new mobile number into a text box of a web page supplied by the web server 206. The web server 206 receives the new number and forwards it to a business rules server 213 including a database 215. The business rules server 213 checks that the number is 10 digits and starts with 04 confirming that the number is an Australian number and also checks that the number is unique to the system 200 by comparing the number against records on the database 215. The business rules server 213 then instructs the SMS request server 211 to send an authentication code to the new phone number. The user 202 retrieves the authentication code from the mobile handheld device with the new number and sends it back as a string of characters to the system 200 via another web page served by web server 206. If the string of characters received by the web server 206 matches the authentication code sent by the web server 206 then the mobile phone number recorded on the database 215 is changed.

In some cases the user 202 does not have a mobile number. In this case, the user 202 can ring an administrator 217 of the system 200 and gives a home or office number to the administrator 217. The telephone call is then terminated and the administrator then rings the user 202 back to verify that the telephone number is a legitimate number. The administrator 217 enters the website via the computer 219 and enters a special number in the mobile number box 336 of FIG. 9 which overrides the system. An authorization code is then generated by the system 200 which is forwarded to the user 202 by either email or over the phone, for example, for entry into a web page such as at FIG. 9.

The method 100 and system 200 for authenticating a prospective user may be advantageously used in registering users of a website that is an online market place for trades and services, such as www.whocando.com.au. The services may include, for example, the provision of a design for a building extension, the renovation of a bathroom, the cleaning of a gutter, the splitting of fire wood and household chores. This website provides a method of providing a tradesman or service provider 221. The user 202 posts on the website a job that needs doing, that is a service request. Tradesmen and service providers 221 can then view the posted job on their computer 223 and place a bid for performing the job or providing the service. The tradesmen or service provider 221 can find many such postings and bid on more than one posting. The person 210 can then select one of the bids which is then awarded to the associated tradesman or service provider 221. This market place can operate in several ways. Firstly, the user 202 can define a maximum price for the job, and the bidders, that is the tradesman or service providers 221, undercut each other. Secondly, a ceiling price may be set by the user 210. Thirdly, no ceiling may be set by the user 210, and in this case the system operates similarly to a quotation process or a tender system. In all these cases, the user 210 can reject all bids or select any bid. For services there are bid selection criteria other than price which are important, such as the certificates held by the tradesman or service provider 221, their reputation, awards for their work or any other relevant factors. It will be appreciated that the system 200 is unique in that is a market place for trades and services, however it can also be adapted for products, such as for the bulk supply of office materials. The method and system may be advantageously used on retail websites and auction websites, or indeed many other types of website.

In this embodiment, the system 200 also includes means for sending a notification email to a person nominated by the prospective user (who is now registered and may be a user) notifying the nominated person of the website. The system provides a web page 330, shown in Fig, which includes a text box 362 for entering the nominated person's email address and another box 364 including an invitation message to be included in the email. The invitation message 364 may be, for example:
Justin Blows is a member of WhoCanDo.com.au and thinks you might be interested in joining in the benefits of WhoCanDo.
WhoCanDo.com.au is Australia's marketplace for trades & services—a place where you save time & money; a place where you can find great tradesmen and service providers and where you can find new business and customers.
To access your FREE membership of WhoCanDo, please click on the link below.
Your WhoCanDo team
auction jobs online
Need to get work done?—Get Your free Membership from whoCanDo at https://www.whocando.com.au/?q=user/register/referer/a/54/535 today!

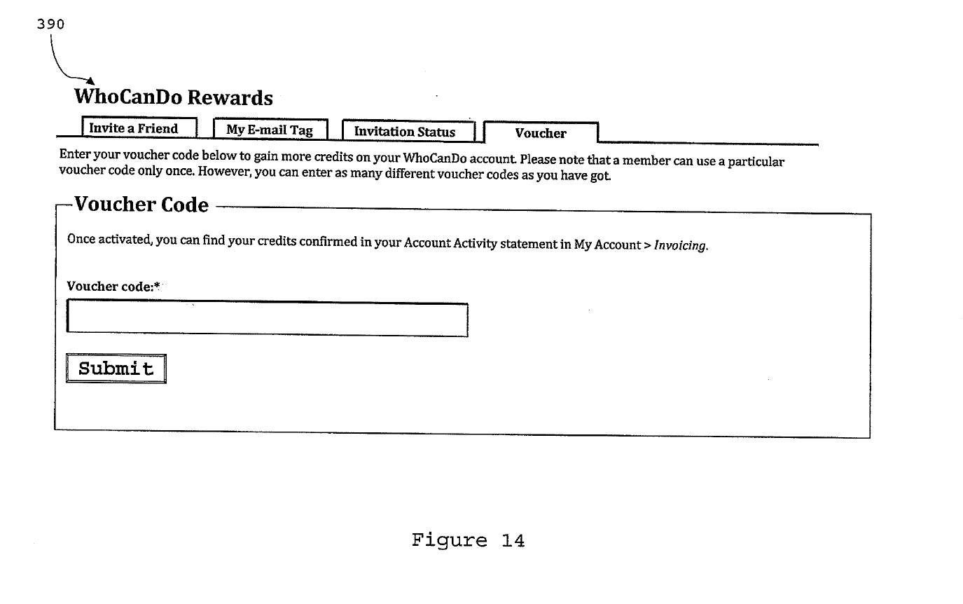

The email is then sent by email server 209 to the nominated person. If the nominated person clicks on the link in the email and subsequently uses the website the prospective user may be rewarded. For example, the prospective user 202 may be rewarded for the nominated person starting a reverse auction tender or quotation process. The reward may be in the form of a voucher redeemable at a web page such as 390 shown in FIG. 14. The message 364 includes an email tag including information uniquely identifying the prospective user which allows the system to track the referring party. In this case, the following link (URL and/or URI) is included:
https://www.whocando.com.au/?q=user/register/referer/a/54/535.

The information identifying the user is the query part of the URL following the question mark and the web address of the website, which in this case,is: 9=user/register/refer/a54/535

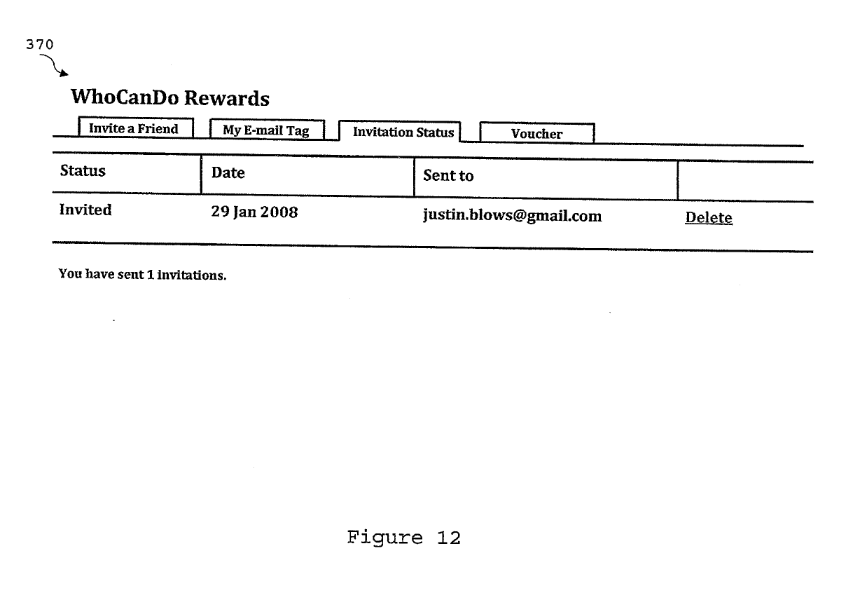

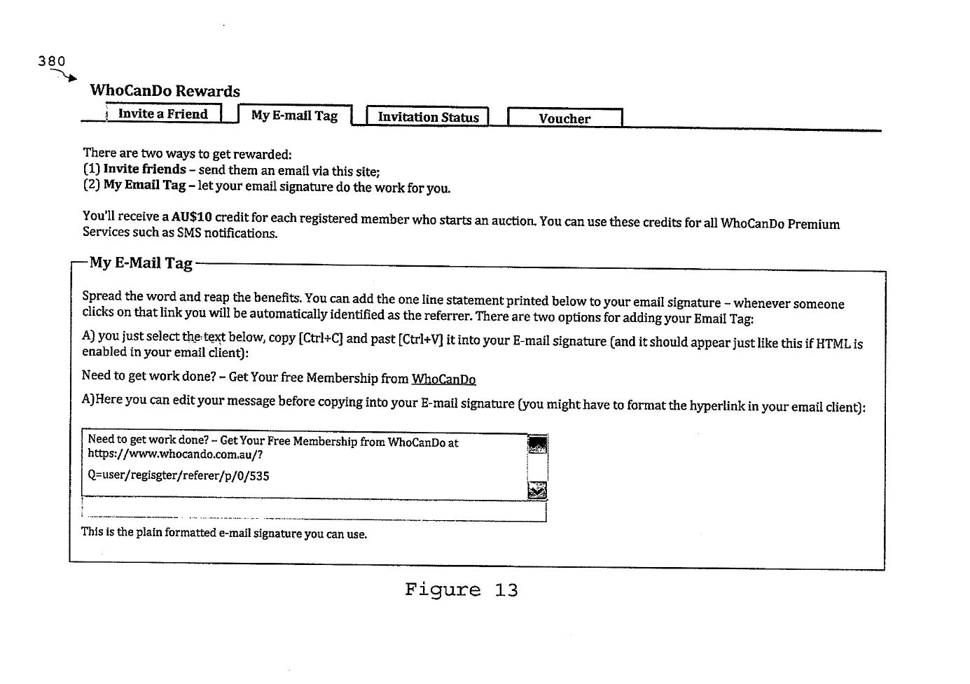

Rewards and invitations to use WhoCanDo initiated by the user 202 can be monitored at a web page such as 370 shown in FIG. 12. Alternatively, as shown in FIG. 13, the system sends a web page 380 including text 382 which takes the form of an email tag including a URL that can be included at the bottom of a plurality of emails sent by the nominated person to a plurality of persons. The email tag passively promotes the website, instead of sending an email with the sole purpose of promoting the site. The URL includes information uniquely identifying the prospective user.

Some embodiments of a system and method for authenticating a prospective user have some of the following advantages:
Instead of a single channel for authentication, such as email, two channels including email and SMS is required for authentication. While it is easy to create additional and/or fraudulent email addresses using Hotmail™, for example, it is much more difficult to create additional or fraudulent mobile phone numbers. Thus it is much more likely that there will be a one to one correspondence between real persons and registered users. This extra security is especially important for websites which include a reward program that can be abused by fraudulent identities;
During the registration process both an email address and a phone number is provided to the system which provides two channels of communication to the user, which increases the chance of successfully contacting the user;
An email address is provided which can be used as a general communication channel which is very cheap. It can contain more information than a message sent to the user via SMS. However, a SMS can be sent in the case of special promotions and advertising campaigns, for example, where maximum impact is required.
The authentication system and process using both email and SMS is desirable in an auction or reverse auction process which involves bidding from multiple people. It prevents fraudulent bids from multiply registered identities. It prevents children bidding who do not have a mobile phone.
The phone number is generally traceable to a real person through official or telephone providers records.
Users can be blocked or denied access to the web site as most users only have a single phone number.
The telephone number can be used an unique identifier for a person, especially if that person only has a single mobile phone.

It will be appreciated that numerous variations and/or modification may be made to the specific embodiments without departing from the spirit and scope of the invention as broadly described. For example, the SMS gateway may be incorporated in the system. The portable handheld device may be any portable handheld device which an associated telephone number or indeed any SMS capable device with a associated number. The method of authentication may not be limited to use during registration for a website, but may be used at any time when some form of authentication is required. The system may be located on a single physical device such as a single server. The connection between the system and the computer may not be over the internet but some other network such as a local or wide area network or WiFI, WiMax Blue tooth or any other suitable network. The computer and the mobile handheld device may be the same device. The handheld device may be a pager. The message sent to the device may be over similar or analogous message service to the Short Message Service. The present embodiments are, therefore, to be considered in all respects as illustrated and not restrictive.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A process for authenticating a prospective user, the process comprising the steps of:
receiving an address of an email account associated with the prospective user;
receiving a device number of a device associated with the prospective user;
sending an email containing authentication information to the email account;
sending different authentication information to the device;
receiving a first message and a second message from the prospective user;
confirming that the first message includes the authentication information contained in the email; and
confirming that the second message includes the different authentication information sent to the device.

2. A process as defined by claim 1 wherein the step of sending the different authentication information to the device may include the step of sending the different authentication information to a mobile or cell telephone over a Short Message Service (SMS).

3. A process as defined by claim 1 wherein the step of receiving the address of the email account and the device or telephone number includes a prior step of providing one or more web pages.

4. A process as defined by claim 1 wherein the process also includes the step of confirming that the device or telephone number corresponds to a predetermined geographical region.

5. A process as defined by claim 1 wherein the step of receiving a first message and a second message includes the step of providing a web page arranged for the user to enter the first message and the second message.

6. According to another aspect of the present invention there is provided a system for authenticating a prospective user, the system comprising:
an address receiver for receiving an address of an email account associated with the prospective user;
a device number receiver for receiving a device number of a device associated with the prospective user;
an email sender for sending an email containing authentication information to the email account;
a message sender for sending different authentication information to the device;
a message receiver for receiving a first message and a second message from the prospective user; and
a confirmer for confirming that the first message includes the authentication code contained in the email and confirming that the second message includes the another authentication code sent to the device.

7. A system of claim 6 including a web server connected to the internet.

8. A system of claim 7 wherein the address receiver and device number receiver include the web server.

9. A system of claim 6 wherein the email sender is an email server.

10. A system of claim 6 wherein the message receiver and confirmer include the web server.

11. A system of claim 6 wherein the message sender includes a SMS server.

12. A system of claim 6 wherein the email sender is arranged for sending an email to a person nominated by a user of the system notifying the nominated person of the website.

13. A system of claim 6 arranged to provide a URL and/or a URI to the prospective user including information uniquely identifying the user.

14. A system of claims 12 arranged to reward the prospective user for the nominated person starting a reverse auction, tender or quotation process.

15. A system of claim 13 wherein the URL and/or URI is included at the bottom of a plurality of emails sent by the nominated person to a plurality of persons.

16. A process for authenticating a prospective user, the process comprising the steps of:
sending an address of an email account associated with the respective user;
sending a device number of a device associated with the respective user;
receiving an email containing authentication information in the email account;
receiving different authentication information via the device; and
sending a first message and a second message corresponding to the and the different authentication information respectively.

17. A computer program comprising instructions for controlling a computer to implement the process of claim 1.

18. A computer readable medium providing the computer program of claim 17.

19. A computer program comprising instructions for controlling a computer to implement the process of claim 16.

20. A computer readable medium providing the computer program of claim 19.
